(19) United States
(12) Patent Application Publication
(10) Pub. No.: US 2012/0144496 A1
(43) Pub. Date: Jun. 7, 2012

(54) ELECTRONIC DEVICE WITH DATA PROTECTION FUNCTION AND METHOD THEREOF

(75) Inventor: XIN GUO, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/196,906

(22) Filed: Aug. 3, 2011

(30) Foreign Application Priority Data
Dec. 4, 2010 (CN) 201010573644.1

(51) Int. Cl. G06F 21/24

(52) U.S. Cl. 726/26

(57) ABSTRACT

The present disclosure provides an electronic device with a data protection function. The device includes a display, an input unit, and a processor. The display displays content of a document and a cursor. The input unit generates mode switching signals in response to a user input. The mode switching signals is for switching operational modes of the electronic device between a normal mode and a data protection mode. The processor switches the device to the data protection mode upon receiving the mode switching signals when in the normal mode, and displays a color layer on the display to cause content selected through the cursor to be visible and unselected content to be invisible when in the data protection mode. A related method is also provided.

### BACKGROUND

1. Technical Field

The present disclosure relates to electronic devices, and particularly, to an electronic device having a data protection function and a method for protecting data.

2. Description of Related Art

When using a computer to look up some files, for example, a contract, the file is usually opened in a maximized window, so a user can quickly read the content of the file. As the computer screen is relatively large, looking up confidential files in the presence of other people may compromise the content of the confidential files.

### BRIEF DESCRIPTION OF THE DRAWINGS

The components of the drawings are not necessarily drawn to scale, the emphasis instead being placed upon clearly illustrating the principles of an electronic device with a data protection function and a method thereof. Moreover, in the drawings, like reference numerals designate corresponding parts throughout several views.

FIG. 1 is a block diagram of an electronic device with a data protection function, in accordance with an exemplary embodiment.

FIG. 2 is a schematic view showing content displayed on the electronic device of FIG. 1.

FIG. 3 is a schematic view showing some of the content displayed on the electronic device of FIG. 1 being hidden.

FIG. 4 is a schematic view showing some of the content displayed on the electronic device of FIG. 1 being hidden, but slightly different from FIG. 3.

FIG. 5 is a flowchart of a method for protecting data in accordance with an exemplary embodiment.

### DETAILED DESCRIPTION

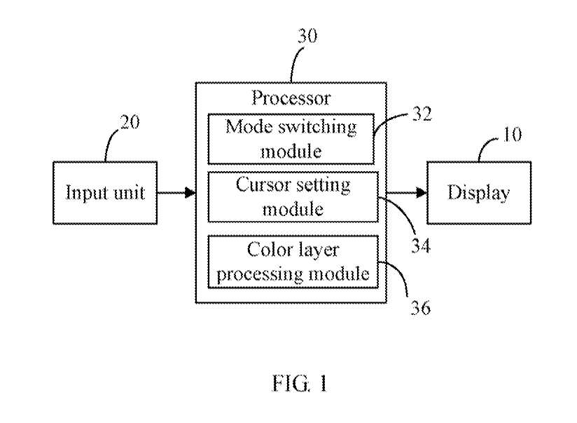

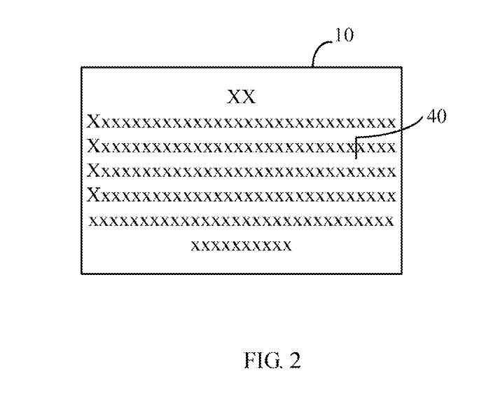

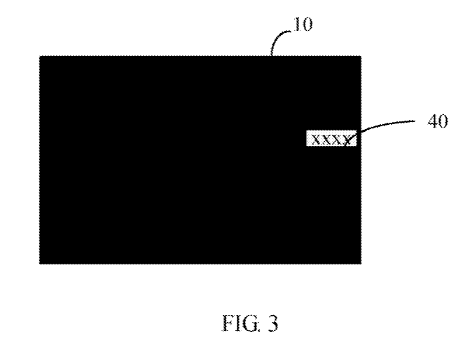

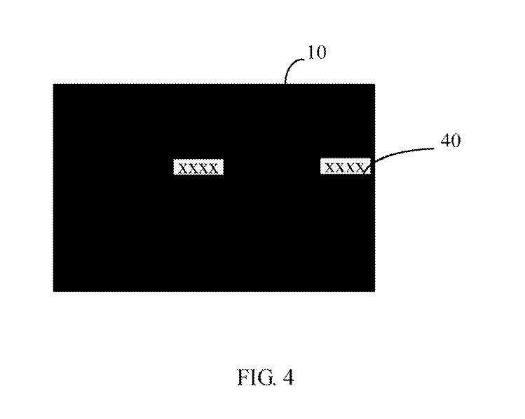

Referring to FIG. 1, an electronic device 100 with a data protection function is illustrated. The device 100 includes a display 10, an input unit 20, and a processor 30. The device 100 may be a computer. The input unit 20 may be a mouse, or may include the mouse and a keyboard. The device 100 includes a normal mode and a data protection mode. The normal mode is a default mode of the device 100. That is, when the device 100 is powered on, the device 100 enters the normal mode. In the normal mode, content of a document and a cursor 40 displayed on the display 10 are visible (see FIG. 2). In the data protection mode, the device 100 displays a color layer such as a black layer on the display 10 to cause selected content of a document to be visible and unselected content to be invisible (see FIG. 3). In this embodiment, when entering the data protection mode, the device 100 sets the shape of the cursor 40 to be a specific shape, for example rectangular, so as to directly select some content by the cursor 40 without dragging the mouse. In this embodiment, the content selected by the cursor 40 is visible, and the content unselected by the cursor 40 is invisible. In an alternative embodiment, when entering the protection mode, the device 100 does not set the shape of the cursor 40 to be the specific shape, that is, the shape of the cursor 40 is the same no matter which mode the device 100 is. A user can press a left button of the mouse and drag the mouse to move the cursor 40 to select desired content from the content which is displayed invisibly. After the cursor 40 is moved, the previously selected content is hidden by the color layer and becomes invisible, and the currently selected content becomes visible. If the device 100 receives a confirm command before the cursor 40 is moved, the device 100 will cause the selected content to be still visible after the cursor 40 is moved (see FIG. 4). If the device 100 determines that previously selected content which is still visible is selected by the cursor 40 once again, the device 100 displays the color layer on the previously selected content to cause the previously selected content to be invisible.

In this embodiment, the processor 30 includes a mode switching module 32, a cursor setting module 34, and a color layer processing unit 36.

The mode switching module 32 switches the operational modes of the device 100 between the normal mode and the data protection mode according to mode switching signals from the input unit 20.

The cursor setting module 34 sets the shape of the cursor 40 to a specific shape when the device 100 enters the data protection mode, so as to directly select some content by the cursor 40 without dragging the mouse. In an alternative embodiment, the cursor setting module 34 may be absent from the device 100. The user can press the left button of the mouse and drag the mouse to move the cursor 40 to select desired content.

The color layer processing module 36 displays a color layer such as a black layer on the display 10 to cause selected content of a document to be visible and unselected content to be invisible when the device 100 enters the data protection mode. The color layer processing module 36 further causes the selected content to be still visible after the confirm command is received before the cursor 40 is moved, and displays the color layer on previously selected content which is still visible to cause the previously selected content to be invisible when the previously selected content is selected by the cursor 40 once again.

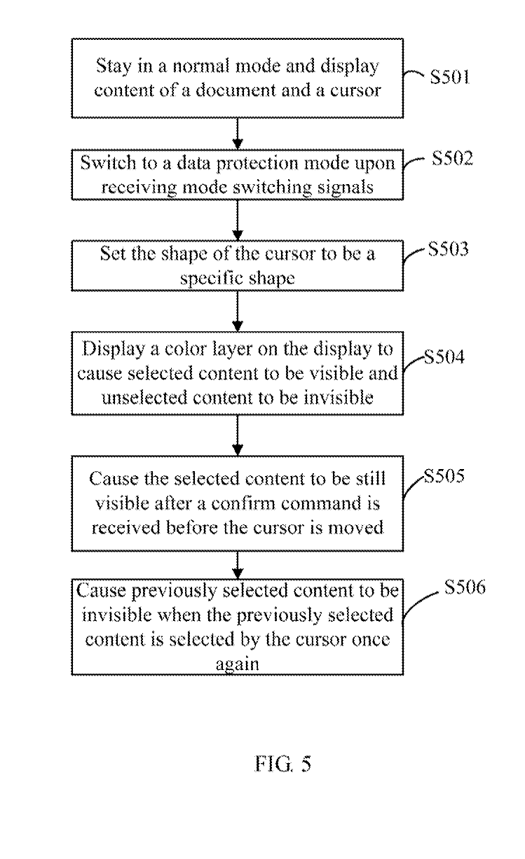

FIG. 5 is a flowchart of a method for protecting data in accordance with an exemplary embodiment.

In step S501, the device 100 stays in the normal mode and displays content of a document and the cursor 40.

In step S502, the mode switching module 32 receives the mode switching signals and switches the device 100 to the data protection mode.

In step S503, the cursor setting module 34 sets the shape of the cursor 40 to be a specific shape, so as to directly select some content by the cursor 40 without dragging the mouse.

In step S504, the color layer processing module 36 displays a color layer on the display 10 to cause content selected by the cursor 40 to be visible and unselected content to be invisible.

In step S505, the color layer processing module 36 causes the selected content to be still visible after the confirm command is received before the cursor 40 is moved.

In step S506, the color layer processing module 36 displays the color layer on previously selected content which is still visible to cause the previously selected content to be invisible when the previously selected content is selected by the cursor 40 once again.

In an alternative embodiment, when entering the protection mode, the device 100 does not set the shape of the cursor 40 to be a specific shape, that is, the shape of the cursor 40 is the same no matter which mode the device 100 is. The user can press the left button of the mouse and drag the mouse to move the cursor 40 to select desired content.

In this embodiment, when the device 100 is in the data protection mode, only the selected content of a document is visible, thus the whole content of the document will not be easily obtained by others around the device 100.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device with a data protection function, comprising:
a display to display content of a document and a cursor;
an input unit to generate mode switching signals in response to a user input, the mode switching signals being for switching operational modes of the electronic device between a normal mode and a data protection mode; and
a processor to switch the electronic device to the data protection mode upon receiving the mode switching signals when the electronic device is in the normal mode, display a color layer on the display to cause content of the document selected through the cursor to be visible and unselected content of the document to be invisible when the electronic device is in the data protection mode.

2. The electronic device as described in claim 1, wherein the input unit comprises a mouse, the processor is further to set the shape of the cursor to be a specific shape when the electronic device enters the data protection mode.

3. The electronic device as described in claim 2, wherein the specific shape is rectangular.

4. The electronic device as described in claim 1, wherein the input unit is further to generate a confirm command in response to user input, the processor is further to cause the selected content of the document to be still visible after the confirm command is received before the cursor is moved.

5. The electronic device as described in claim 4, wherein the processor is further to display the color layer on previously selected content of the document which is still visible to cause the previously selected content of the document to be invisible when the previously selected content of the document is selected through the cursor once again.

6. A method for protecting data applied in an electronic device, the method comprising:
staying in a normal mode and displaying content of a document and a cursor;
switching the electronic device to a data protection mode upon receiving mode switching signals; and
displaying a color layer to cause content of the document selected through the cursor to be visible and unselected content of the document to be invisible.

7. The method as described in claim 6, further comprising:
setting the shape of the cursor to be a specific shape when the electronic device enters the data protection mode.

8. The method as described in claim 7, wherein the specific shape is rectangular.

9. The method as described in claim 6, further comprising:
causing selected content of the document to be still visible after a confirm command is received before the cursor is moved.

10. The method as described in claim 6, further comprising:
displaying the color layer on previously selected content of the document which is still visible to cause the previously selected content of the document to be invisible when the previously selected content of the document is selected through the cursor once again.
